(19) United States
(12) Patent Application Publication
(10) Pub. No.: US 2012/0171435 A1
(43) Pub. Date: Jul. 5, 2012

(54) Dyes and Their Use in Ink-Jet Printing

(75) Inventors: Clive Edwin Foster, Manchester (GB); Zyta Victoria Morgan, Manchester (GB)

(73) Assignee: Fujifilm Imaging Colorants Limited, Manchester (GB)

(21) Appl. No.: 13/395,343

(22) PCT Filed: Aug. 11, 2010
(86) PCT No.: PCT/GB10/51329

§ 371 Date: Mar. 9, 2012

(30) Foreign Application Priority Data
Sep. 11, 2009 (GB) 0915960.9
Sep. 11, 2009 (GB) 0915963.3

(51) Int. Cl. C09D 11/02; B32B 3/10; B41J 2/175; C09B 49/04

(52) U.S. Cl. 428/195.1; 534/756; 534/763; 534/754; 106/31.48; 347/86; 347/20

(57) ABSTRACT

A dye of Formula (1) and salts thereof:

A-N═N-(M-N═N)ₓ-E Formula (1)

wherein:
A is optionally substituted aryl carrying at least one substituent selected from the group consisting of —SO₃H, —CO₂H, and —PO₃H₂;
M is optionally substituted arylene;
E is optionally substituted heteroaryl; and
x is 1 or 2. Also compositions, dye mixtures, printing processes, printed material and ink-jet cartridges.

This invention relates to disazo dyes, compositions and inks, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

While ink-jet printers have many advantages over other forms of printing and image development there are still technical challenges to be addressed. For example, there are the contradictory requirements of providing ink colorants that are soluble in the ink medium and yet display excellent wet-fastness (i.e. prints do not run or smudge when printed). The inks also need to dry quickly to avoid sheets sticking together after they have been printed should not form a crust over the tiny nozzles used in the printer. Storage stability is also important to avoid particle formation that could block the print-head nozzles especially since consumers can keep an ink-jet ink cartridge for several months. Furthermore, and especially important with photographic quality reproductions, the resultant images should not bronze or fade rapidly on exposure to light or atmospheric oxidising gases such as ozone.

With the advent of high-resolution digital cameras it is becoming increasingly common for consumers to print photographs using an ink-jet printer. This application is particularly demanding since a gamut of colours needs to be accurately and realistically reproduced. This is commonly achieved by applying the different inks to varying degrees. Thus, it is especially important that the shade and chroma of the each applied ink is exactly right so that an image may be optimally reproduced.

Thus, the skill of an ink-jet chemist lies not only in developing new colorants but also in identifying those colorants which may be combined with existing colorants to optimise their optical properties and performance in an ink-jet printer.

The present invention provides a disazo or trisazo dye of Formula (1) and salts thereof:

A-N═N-(M-N═N)ₓ-E Formula (1)

wherein:
A is optionally substituted aryl carrying at least one substituent selected from the group consisting of —SO₃H, —CO₂H, and —PO₃H₂;
M is optionally substituted arylene;
E is optionally substituted heteroaryl; and
x is 1 or 2.

Preferably A is optionally substituted phenyl carrying at least one substituent selected from the group consisting of —SO₃H, —CO₂H, and —PO₃H₂ or optionally substituted naphthyl carrying at least one substituent selected from the group consisting of —SO₃H, —CO₂H, and —PO₃H₂.

Preferably A carries 1 to 3 substituents selected from the group consisting of —SO₃H, —CO₂H, and —PO₃H₂. More preferably A carries 1 to 3 substituents selected from the group consisting of —SO₃H and —CO₂H (especially —SO₃H).

M is preferably (independently when x is 2) optionally substituted phenylene or optionally substituted naphthylene.

E is preferably an optionally substituted heteroaryl ring selected from the group consisting of; thienyl, furyl, pyrrolyl, pyridyl, pyrimidyl, pyrazinyl, triazinyl, imidazolyl, thiazolyl, oxazolyl, pyrazolyl, triazolyl, indolyl, benzothiophenyl, benzimidazolyl, benzothiazolyl, benzoxazolyl, thienothiazolyl, purinyl, quinolinyl, isothiazolyl and isoquinolinyl. More preferably E is optionally substituted pyridyl or optionally substituted pyrimidyl. It is especially preferred that E is an optionally substituted pyridyl.

Optional substituents which may be present on A, M and E are preferably independently selected from the group consisting of optionally substituted alkyl (preferably optionally substituted C₁₋₄-alkyl), optionally substituted alkoxy (preferably optionally substituted C₁₋₄-alkoxy), optionally substituted aryl (preferably optionally substituted phenyl), optionally substituted aryloxy (preferably optionally substituted phenoxy), optionally substituted heterocyclyl, polyalkylene oxide (preferably polyethylene oxide or polypropylene oxide), phosphonate, —PO₃H₂, —CO₂H, nitro, —CN, isonitrile, halo, ureido, quaternary amine, —SO₃H, —SO₂F, hydroxy, ester, —NR^{a}R^{b}, —COR^{a}, —CONR^{a}R^{b}, —NHCOR^{a}, sulfoxide, sulfone, and —SO₂NR^{a}R^{b}, wherein R^{a} and R^{b} are each independently H, optionally substituted alkyl (especially C₁₋₄-alkyl), optionally substituted aryl, or optionally substituted heteroaryl. Optional substituents for any of the substituents described above may be selected from the same list of substituents.

Preferred optional substituents for A are optionally substituted alkoxy (preferably optionally substituted C₁₋₄-alkoxy, more preferably unsubstituted C₁₋₄-alkoxy), —NR^{a}R^{b}, —NHCOR^{a}, nitro, —CO₂H and —SO₃H, wherein R^{a} and R^{b} are as defined above.

Preferred optional substituents for M are; water solubilising groups (preferably —SO₃H, —CO₂H, and —PO₃H₂), optionally substituted C₁₋₄-alkyl and optionally substituted C₁₋₄-alkoxy.

Preferably M carries at least one substituent and when x is 2 each M independently carries a substituent.

When x is 1 M preferably carries a single —SO₃H or —CO₂H (especially —SO₃H) substituent.

When x is 2 preferably at least one M and more preferably both M's independently, carry a single alkoxy (especially optionally substituted C₁₋₄-alkoxy, more preferably unsubstituted C₁₋₄-alkoxy), —SO₃H or —CO₂H.

Preferably E is optionally substituted pyridyl.

Preferred optional substituents for E are —CN; optionally substituted C₁₋₄ alkyl (especially methyl); —NR^{c}R^{d}, wherein R^{c} and R^{d} are independently H, optionally substituted C₁₋₄ alkyl or optionally substituted phenyl (preferably carrying a substituent selected from —CO₂H and —SO₃H).

It is particularly preferred that E is of Formula (2)

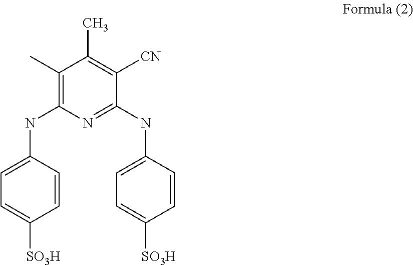

When x is 1 then in one preferred embodiment the dye of Formula (1) is a disazo dye of Formula (3) and salts thereof.

A-N═N-M-N═N-E Formula (3)

A, M and E are as described and as preferred above.

A particularly preferred disazo dye of Formula (3) is a disazo dye of Formula (4) and salts thereof

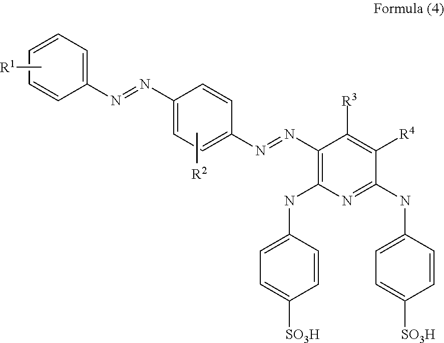

wherein:

R¹ and R² are independently —SO₃H or —CO₂H;

R³ is optionally substituted C₁₋₄alkyl; and

R⁴ is an electron withdrawing group.

Preferably R¹ and R² are —SO₃H.

Preferably R³ is methyl.

Preferably R⁴ is —CN.

More preferred disazo dyes of Formula (3) are of Formula (5) and salts thereof

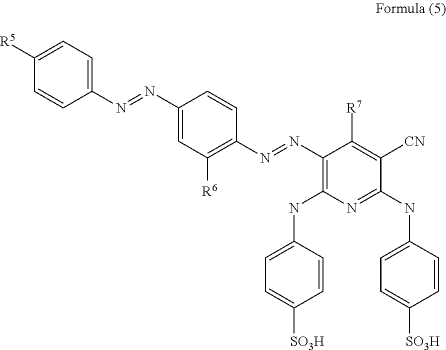

wherein:

R⁵ and R⁶ are independently —SO₃H or —CO₂H; and

R⁷ is C₁₋₄alkyl.

Preferably R⁵ and R⁶ are —SO₃H.

Preferably R⁷ is methyl.

Optional substituents which may be present on R³ may be selected from the list of preferred substituents given above for A, M and E (apart from optionally substituted alkyl).

In another preferred embodiment the dye of Formula (1) is a trisazo dye of Formula (6) and salts thereof.

A-N═N-M1-N═N-M2-N═N-E Formula (6)

wherein:
A is optionally substituted aryl carrying at least one substituent selected from the group consisting of —SO₃H, —CO₂H, and —PO₃H₂;
M1 and M2 are independently optionally substituted arylene; and
E is optionally substituted heteroaryl.
A and E are as described and as preferred above. M1 and M2 are independently as described and preferred above for M.

The dyes of Formula (1) are also preferably free from fibre reactive groups. The term fibre reactive group is well known in the art and is described in, for example, EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups excluded from the dyes of Formula (1) there may be mentioned aliphatic sulfonyl groups which contain a sulfate ester group in beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring, for example a triazinyl halide.

Acid or basic groups on the dyes of Formula (1), particularly acid groups, are preferably in the form of a salt. Thus, all Formulae shown herein include the dyes in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially lithium and sodium salts. Dyes of Formula (1) where lithium is the major salt form are especially preferred. Dyes of Formula (1) may be converted into a salt using known techniques.

The dyes of Formula (1) may exist in tautomeric forms other than those shown in this specification. These tautomers are included within the scope of the present invention.

The dyes of Formula (1) may be prepared by any method known in the art, and particularly by processes such as those described in WO 03/087238 which is incorporated herein by reference.

The dyes of Formula (1) are valuable colorants for use in the preparation of ink-jet printing inks. They benefit from a good balance of solubility, storage stability and fastness to water, ozone and light. In particular they display excellent ozone fastness.

According to a second aspect of the present invention there is provided a composition comprising a dye of Formula (1) and/or a salt thereof, as described in the first aspect of the invention, and a liquid medium.

Preferred compositions according to the second aspect of the invention comprise:
(a) from 0.01 to 30 parts of a dye of Formula (1) and/or a salt thereof according to the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, then preferably a polar solvent is included since this enhances solubility of the mixture of dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

It is preferred that the composition according to the invention is ink suitable for use in an ink-jet printer. Ink suitable for use in an ink-jet printer is ink which is able to repeatedly fire through an ink-jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20 cP, more preferably less than 10 cP, especially less than 5 cP, at 25′C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colorant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

The dyes of the first aspect of the present invention are particularly useful for shading black dyes. Therefore a third aspect of the invention provides a mixture of one or more dye(s) of Formula (1) and salts thereof, as described and preferred in the first aspect of the invention, and one or more additional black dye(s) and salts thereof.

The additional black dyes and salts thereof may be any black dye able to be formulated into an ink-jet ink and used in an ink-jet printer. These dyes may be selected from those black dyes listed in the Colour Index, and salts thereof, and those commercially available dyes sold specifically for ink-jet printing. Preferably the black dyes, and salts thereof, are selected from those disclosed in U.S. Pat. No. 7,491,266, and U.S. Pat. No. 7,533,978, which are incorporated herein by reference.

The shade of the mixture of one or more dye(s) of Formula (1) and salts thereof and one or more additional black dye(s) and salts thereof may be modified by the addition of further dyes of other suitable colours.

It is particularly preferred that in the mixture of the third aspect of the invention the dyes of the first aspect of the invention are mixed with one or more additional black dye(s) of Formula (7) and salts thereof, and optionally one or more further dye(s):

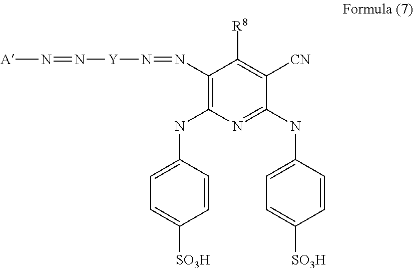

wherein:

A′ is optionally substituted aryl;

Y is optionally substituted thienylene or optionally substituted thiazolylene;

and

R⁸ is H or C₁₋₄alkyl.

Optional substituents are as described in the first aspect of the invention.

Preferred optional substituents for Y are optionally substituted aryl, optionally substituted heteroaryl, esters, —CN and —CO₂H.

R⁸ is preferably methyl.

A fourth aspect of the invention provides a composition comprising a mixture of one or more dye(s) of Formula (1), and salts thereof, and one or more additional black dye(s), and salts thereof, as described in the third aspect of the invention and a liquid medium.

The dye(s) of Formula (1), and salts thereof are as described and preferred in the first aspect of the invention, the additional black dyes are as described and preferred in the third aspect of the invention and the composition and liquid medium are as described and preferred in the second aspect of the invention.

A fifth aspect of the invention provides a process for forming an image on a substrate comprising applying a composition, preferably ink suitable for use in an ink-jet printer, according to the second or fourth aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice.

The substrate is preferably paper, plastic, a textile, metal or glass, more preferably paper, an overhead projector slide or a textile material, especially paper.

Preferred papers are plain or treated papers which may have an acid, alkaline or neutral character. Photographic quality papers are especially preferred.

A sixth aspect of the present invention provides a material preferably paper, plastic, a textile, metal or glass, more preferably paper, an overhead projector slide or a textile material, especially paper more especially plain, coated or treated papers printed with a dye as described in the first aspect of the invention, a composition as described in the second aspect of the invention, a mixture as described in the third aspect of the invention, a composition as described in the fourth aspect of the invention or by means of a process as described in the fifth aspect of the invention.

It is especially preferred that the printed material of the sixth aspect of the invention is a print on a photographic quality paper printed using a process according to the fifth aspect of the invention.

A seventh aspect of the present invention provides an ink-jet printer cartridge comprising a chamber and a composition, preferably ink suitable for use in an ink-jet printer, wherein the composition is in the chamber and the composition is as defined and preferred in the second or fourth aspect of the present invention.

The invention is further illustrated by the following Examples in which all parts and percentages are by weight unless otherwise stated.

### EXAMPLE 1

### Preparation of

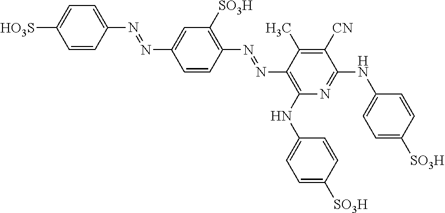

### Stage 1a

### Preparation of the Coupling Component (3-cyano-2,6-diamino(4-sulfophenyl)-4-methylpyridine)

2,6-Dianilino-4-methylnicotinonitrile was prepared analogously to the methods described in U.S. Pat. No. 3,853,895, incorporated herein by reference, from 2,6-dichloro-4-methylnicotinonitrile and an excess of aniline at 120° C. 2,6-Dianilino-4-methylnicotinonitrile (24.0 g, 0.08 g mole) was added to a stirred mixture of sulfolane (56 ml) and ethyl acetate (24 ml). Chlorosulfonic acid (41.9 g; 0.36 g mole) was added to the slurry at 5 to 25° C. in an exothermic reaction. After the addition was complete, the reaction mixture was heated to 40° C. for 4.5 hours. The reaction mixture was cooled to room temperature. The resultant viscous, amber oil was added to water (72 ml) at less than 25° C. to form a greenish/yellow solution which was stirred at room temperature for 30 minutes during which time a cream precipitate formed. The reaction mixture was cooled to 10° C., stirred for 30 minutes an then filtered. The filter cake was washed with acetonitrile (2×60 ml). and dried in a vacuum oven at 60° C. to constant weight 34.7 g (yield 94%)

### Stage 1b

### Preparation of the Title Product

C.I. Acid Yellow 9 (0.01 mol) was stirred in water (200 ml). Concentrated hydrochloric acid (3 ml) was added and the solution was cooled to 0-5° C. A solution of sodium nitrite (0.011 mol) in water (20 ml) was then added and the reaction mixture was stirred for 30 minutes. Excess nitrous acid was destroyed by the addition of sulfamic acid, and then the diazonium salt was added to 3-cyano-2,6-diamino(4-sulfophenyl)-4-methylpyridine (0.011 mol), prepared in stage 1a, in water (100 ml) at 5° C. After 72 hours, the reaction mixture was diluted with acetone (1.5 L) and the resulting precipitate was collected by filtration. The product was washed with acetone and dialysed with Visking tubing after reconstitution at pH 8 in water. After drying the yield was 0.0043 mol.

### EXAMPLES 2-19

The following examples were prepared by analogous processes to those used in Example 1. On occasion the diazotisation was found to be more readily accomplished using isoamylnitrite as the nitrosating agent. This methodology is well known to those skilled in the art.

| Example | |
|---|---|
| number | Dye Structure |
| 2 | 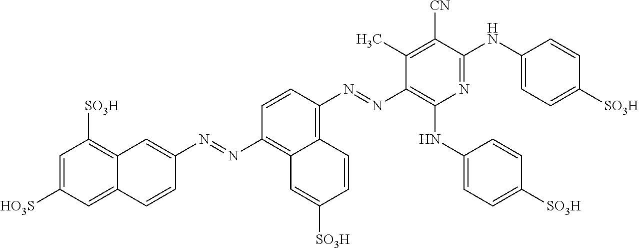 |
| 3 | 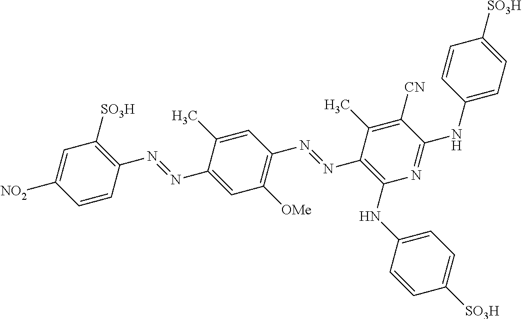 |
| 4 | 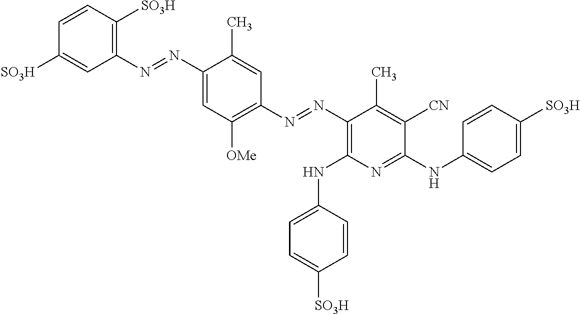 |
| 5 | 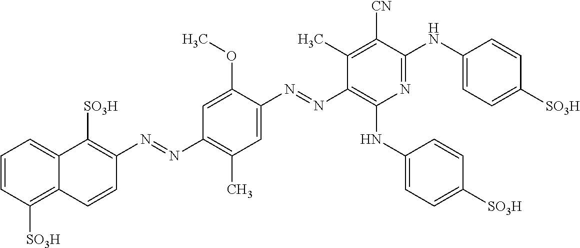 |
| 6 | 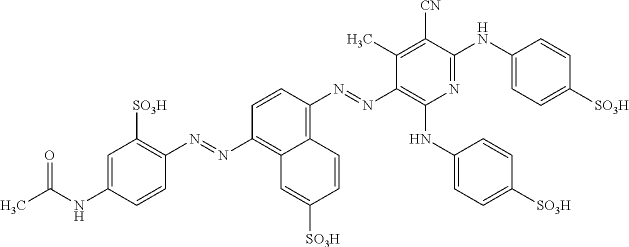 |
| 7 | 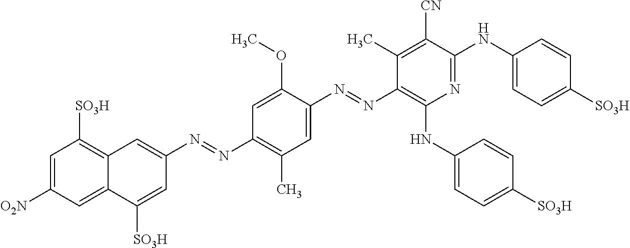 |
| 8 | 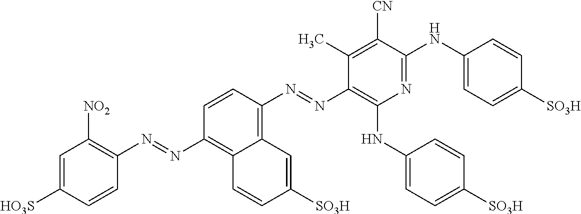 |
| 9 | 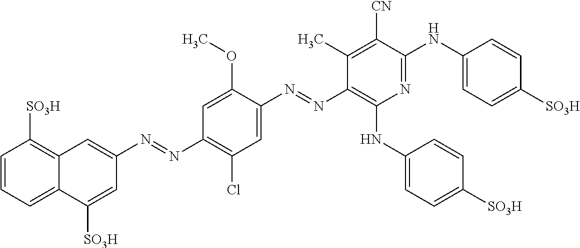 |
| 10 | 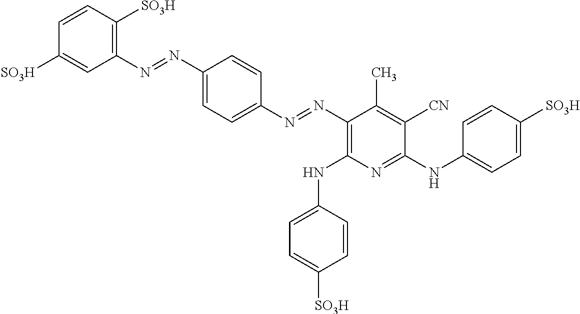 |
| 11 | 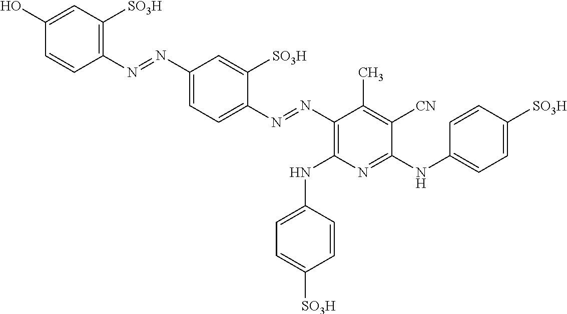 |
| 12 | 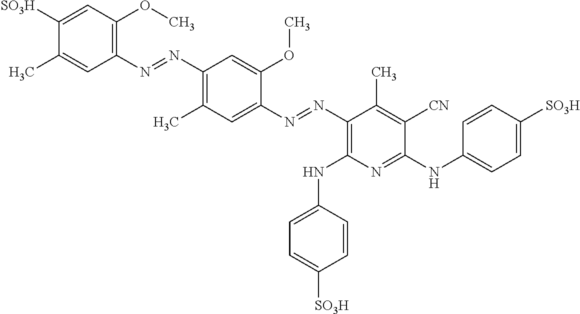 |
| 13 | 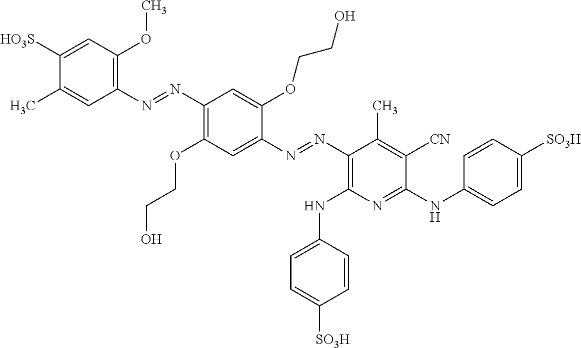 |
| 14 | 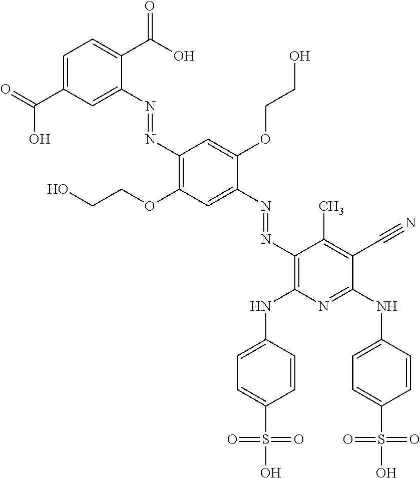 |
| 15 | 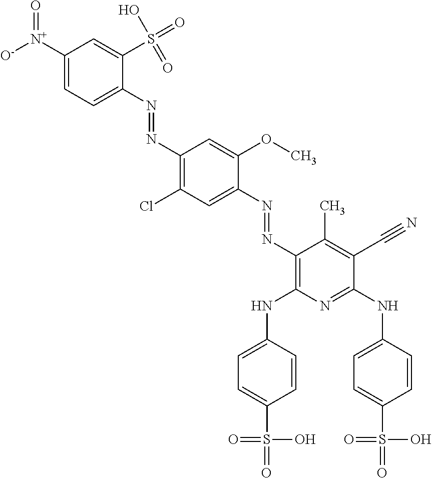 |
| 16 | 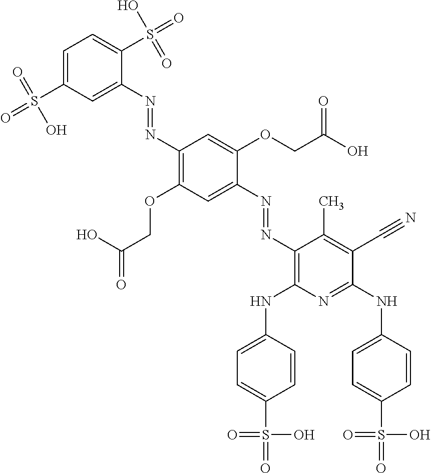 |
| 17 | 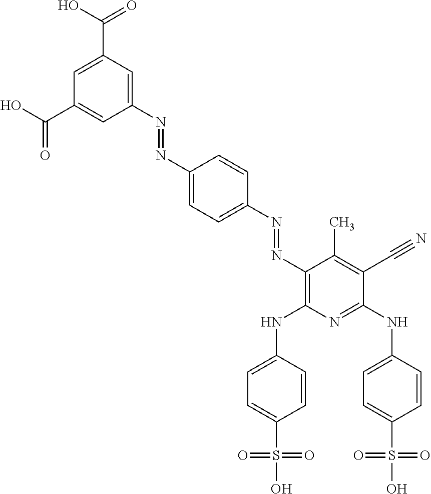 |
| 18 | 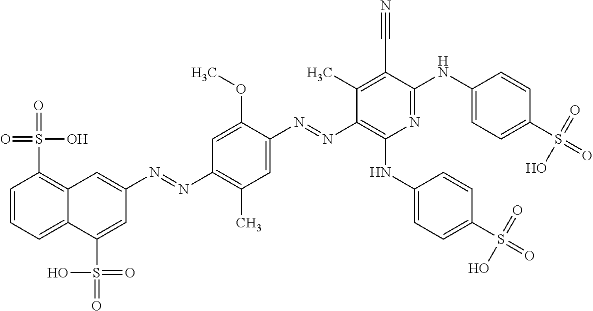 |
| 19 | 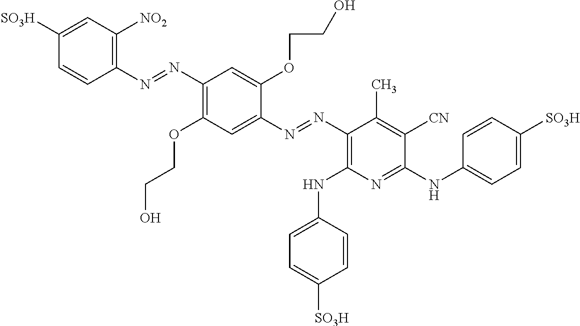 |

### EXAMPLE 20

### Preparation of

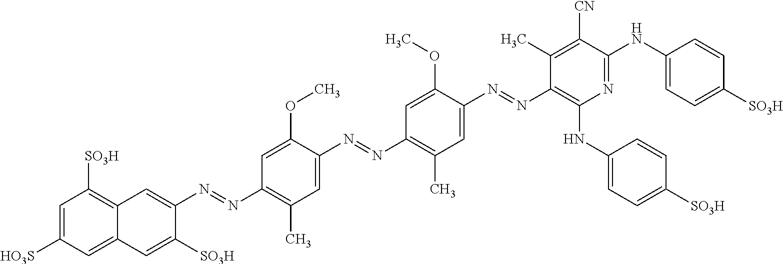

### Stage 1

### Preparation of the Monoazo Intermediate

2-Amino-3,6,8-naphthalenetrisulfonic acid (38.3 g, 0.1 mol) was dissolved in water (500 ml) at pH 7-8 with the addition of 2M lithium hydroxide solution. The solution was filtered and sodium nitrite (6.9 g, 0.1 mol) was added and stirred to dissolve. The solution was then added slowly to a stirred mixture of ice/water (400 g) and 36% hydrochloric acid (30 ml). This mixture was stirred for 1 hour at 0 to 10° C. before destroying any excess nitrous acid with a sulfamic acid solution. A solution of 2-methoxy-5-methylaniline (13.7 g, 0.1 mol) in acetone (200 ml) was then added at 0 to 10° C. to the stirred diazo solution followed by pyridine (10 ml). The reaction mixture was allowed to warm to 20 to 25° C. and stirred overnight. The resultant product suspension was then added to acetone (5 L) and stirred for 10 minutes. The product was filtered off, washed with acetone and dried at 60° C. Weight of product obtained, 45.0 g at 77.5% strength. Yield 66%.

### Stage 2

### Preparation of the Disazo Intermediate

The monoazo dye from Stage 1 (27.4 g at 77.5% strength, 0.04 mol) was stirred in water (300 ml). Sodium nitrite (3.0 g, 0.044 mol) was added to the suspension and this mixture was added slowly at 0 to 5° C. to a solution of 36% hydrochloric acid (20 ml) in water (150 ml). The mixture was stirred for 1.5 hours at 0 to 5° C. before destroying any excess nitrous acid with sulfamic acid solution. A solution of 2-methoxy-5-methylaniline (5.5 g, 0.04 mol) in acetone (100 ml) was then added at 0 to 5° C. to the stirred diazo solution. The pH of the reaction mixture was raised to 6 by the addition of 2M sodium hydroxide solution. The mixture was stirred for 2 hours at 0 to 5° C. before allowing to warm to 20-25° C. and stirring overnight. Solid potassium acetate was added to precipitate the product which was isolated by filtration. The product paste was slurried in ethanol (800 ml) for 30 minutes before filtering, washing with ethanol and drying at 60° C./20 mmHg. Weight product obtained, 26.0 g. Yield 96%.

### Stage 3

### Preparation of the Trisazo Dye

The disazo from Stage 2 (6.8 g, 0.01 mol) was dissolved in water (100 ml) at 20° C. 36% Hydrochloric acid (10 ml) was then added and the solution cooled to 0 to 5° C. A solution of sodium nitrite (1.0 g, 0.014 mol) in water (5 ml) was added drop-wise and the mixture was stirred for 1.5 hours at 0 to 5° C. Any excess nitrous acid is destroyed by the addition of sulfamic acid solution. Then a solution of 4-({3-cyano-4-methyl-6-[(4-sulfophenyl)amino]pyridin-2-yl}amino)benzenesulfonic acid (4.6 g, 0.01 mole) in water (50 ml) was added at 20° C. The reaction mixture was stirred for 15 minutes then heated to 35° C. for 2 hours. The pH was raised to 4.5 by the addition of solid lithium acetate before heating to 70° C. The reaction was continued at 70° C. until analysis indicates that the bulk of the diazo has reacted. When then reaction was deemed complete, then it was cooled to 20° C. and the product was precipitated by the addition of propan-2-ol (400 ml). The crude product was isolated by filtration and washed with propan-2-ol. The product was then dissolved in dilute lithium hydroxide and inorganic material removed by dialysing this solution in Visking tubing. After evaporation of the dialysed solution to dryness, 0.7 g product was obtained. Yield 6%.

### EXAMPLE 21 and 22

Examples 21 and 22 were prepared using analogous techniques to those described above for Example 20. This methodology is well known to those skilled in the art.

| Example | Structure |
|---|---|
| 21 | 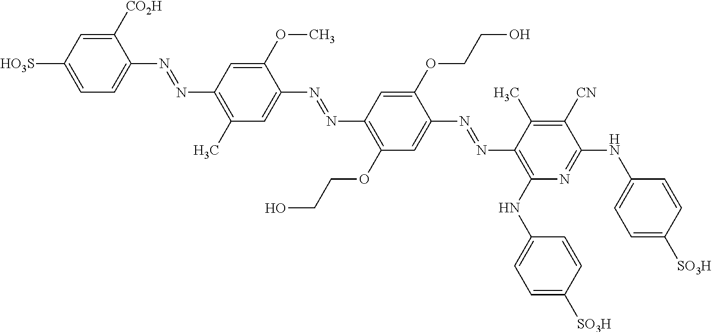 |
| 22 | 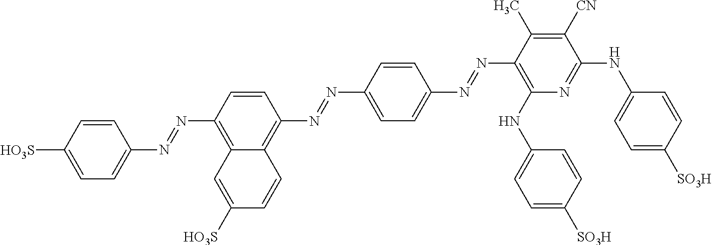 |

### Comparative Dye

The comparative dye C1 was the lithium salt of Example D41 in U.S. Pat. No. 7,192,475:

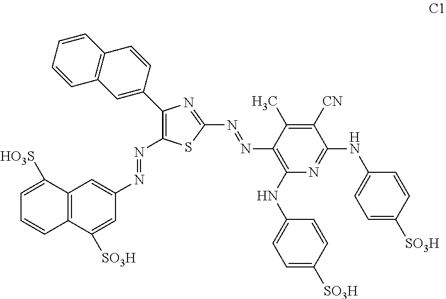

### EXAMPLE 23

### Preparation of Inks

Inks were prepared by dissolving 3 parts by weight of the dye of Examples 1, 9 and C1 to in 97 parts by weight of a liquid medium comprising % by weight:

| | |
|---|---|
| Diethylene glycol | 7% |
| Ethylene glycol | 7% |
| 2-Pyrollidone | 7% |
| Surfynol ™ 465 | 1% |
| Tris buffer | 0.2% |
| Water | 77.8% |

and adjusting the pH of the ink to 8-8.5 using sodium hydroxide.

Surfynol® 465 is a surfactant from Air Products.

### EXAMPLE 24

### Ink-Jet Printing

Ink prepared as described above were filtered through a 0.45 micron nylon filter and then incorporated into empty print cartridges using a syringe.

The inks were printed on to the following media:

These inks were then ink-jet printed on to the following ink-jet media:

Epson® Ultra Premium Glossy Photo Paper (SEC PM);

Canon® Photo Paper Pro Platinum PT101 Photo Paper (PT101); and

HP Advanced Photo Paper (HPP).

The prints were tested for ozone fastness by exposure to 1 ppm ozone at 40° C., 50% relative humidity for 24 hours in a Hampden 903 Ozone cabinet. Fastness of the printed ink to ozone was judged by the difference in the optical density before and after exposure to ozone.

Light-fastness of the printed image was assessed by fading the printed image in an Atlas® Ci5000 Weatherometer for 100 hours and then measuring the change in the optical density.

Optical density measurements can be performed using a Gretag® spectrolino spectrophotometer set to the following parameters:

Measuring Geometry: 0°/45°

Spectral Range: 380-730 nm

Spectral Interval: 10 nm

Illuminant: D65

Observer: 2° (CIE 1931)

Density: Ansi A

External: Filler None

Ozone fastness was assessed by the percentage change in the optical density of the print, where a lower figure indicates higher fastness.

The results are shown below in Table 1

TABLE 1

| Example | SEC PM | PT 101 | HPP |
|---|---|---|---|
| 1 | 5 | 9 | 5 |
| 9 | 4 | 13 | 7 |
| C1 | 5 | 23 | 8 |

From the table it can be seen that Examples 1 and 9, according to the present invention, display a superior ozone fastness.

### Further Inks

The inks described in Tables A and B may be prepared using the dye of Example 1. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink-jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye | | | | | | | |
|---|---|---|---|---|---|---|---|
| Content | Water | PG | DEG | NMP | TBT | BDL | P12 |
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A dye of Formula (1) and salts thereof:
A-N═N-(M-N═N)ₓ-E Formula (1)
wherein:
A is optionally substituted aryl carrying at least one substituent selected from the group consisting of —SO₃H, —CO₂H, and —PO₃H₂;
M is optionally substituted arylene;
E is of Formula (2); 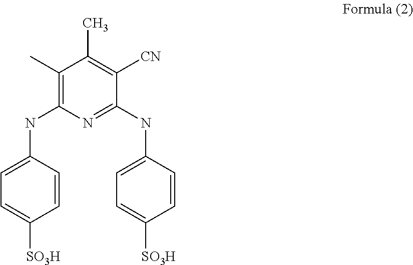
and
x is 1 or 2.

2. A dye of Formula (1) and salts thereof as claimed in claim 1 wherein A carries 1 to 3 substituents selected from the group consisting of —SO₃H and —CO₂H.

3. A dye of Formula (1) and salts thereof as claimed in claim 1 wherein M carries at least one substituent and when x is 2 each M independently carries a substituent.

4. A dye of Formula (1) and salts thereof as claimed in claim 1 wherein
when x is 1,
M carries a single —SO₃H or —CO₂H substituent.

5. A dye of Formula (1) and salts thereof as claimed in claim 1 wherein
when x is 2,
both M's independently carry a single alkoxy, —SO₃H or —CO₂H substituent.

6. (canceled)

7. A dye of Formula (1) and salts thereof, as claimed in claim 1, which is a disazo dye of Formula (4) and salts thereof 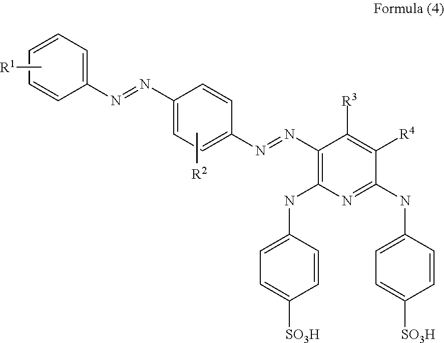
wherein:
R¹ and R² are independently —SO₃H or —CO₂H;
R³ is optionally substituted C₁₋₄alkyl; and
R⁴ is an electron withdrawing group.

8. A dye of Formula (1) and salts thereof, as claimed in claim 1, which is a trisazo dye of Formula (6) and salts thereof
A-N═N-M1-N═N-M2-N═N-E Formula (6)
wherein:
A is optionally substituted aryl carrying at least one substituent selected from the group consisting of —SO₃H, —CO₂H, and —PO₃H₂;
M1 and M2 are independently optionally substituted arylene; and
E is of Formula (2)

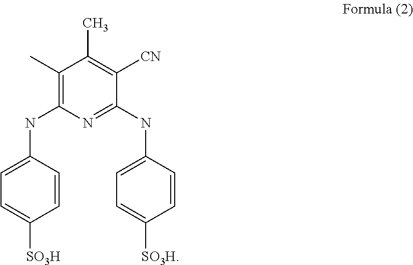

9. A composition comprising a dye of Formula (1) and/or a salt thereof, as described in claim 1, and a liquid medium.

10. A mixture of one or more disazo or trisazo dye(s) of Formula (1) and salts thereof as described in claim 1 and one or more additional black dye(s) and salts thereof.

11. A mixture of one or more disazo dye(s) of Formula (1) and salts thereof and one or more additional black dye(s) and salts thereof, as claimed in claim 10, wherein the additional black dye(s) is of Formula (7) and salts thereof: 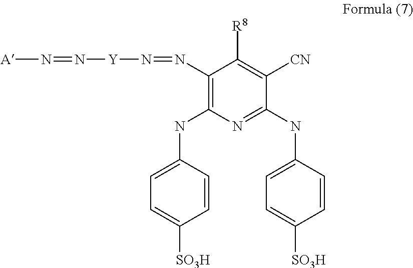
wherein:
A′ is optionally substituted aryl;
Y is optionally substituted thienylene or optionally substituted thiazolylene; and
R⁸ is H or C₁₋₄alkyl.

12. A composition comprising a mixture of one or more disazo dye(s) of Formula (1), and salts thereof, and one or more additional black dye(s), and salts thereof, as described in claim 10 and a liquid medium.

13. A process for forming an image on a substrate comprising applying a composition, according to claim 9, thereto by means of an ink-jet printer.

14. A material printed by means of a process as described in claim 13.

15. An ink-jet printer cartridge comprising a chamber and a composition according to claim 9, wherein the composition is in the chamber.
